(19) United States
(12) Patent Application Publication
(10) Pub. No.: US 2023/0228287 A1
(43) Pub. Date: Jul. 20, 2023

(54) Automatic Greaser Retainer

(71) Applicants: Fred Barton, Hardin, TX (US); Dale Harryman, Hardin, TX (US)

(72) Inventors: Fred Barton, Hardin, TX (US); Dale Harryman, Hardin, TX (US)

(21) Appl. No.: 17/577,853

(22) Filed: Jan. 18, 2022

(51) Int. Cl. F16B 5/12

(52) U.S. Cl. CPC F16B 5/128; F16B 5/125

(57) ABSTRACT

A retaining system provides stability to an automatic greater when attached to a wheel hub. The system includes a hub assembly having a hub base and body, an automatic greater affixed to the hub body, and a retainer having a metal body. The metal body includes pair of wing grips connected by a bridge section. Prongs extend from each wing grip and terminate at first and second ends. Retainer tips extend from each end toward opposing prongs. When in an engaged configuration, the metal body of the retainer may simultaneously engage an interior surface of the automatic greater and an outer surface of the hub body so that the automatic greater is secure and removably affixable from the hub body. To secure the retainer to the hub body, the pair of tips are positioned within a pair of orifices located on the outer surface of hub body.

### FIELD OF THE INVENTION

The present invention is directed to a clip with a plurality of prong-shaped ends for insertion into an automatic greaser.

### BACKGROUND OF THE INVENTION

The regular lubrication of wheel hub bearings is a requirement to ensure that a bearing does not get damaged or dry out over time. Wheel hub bearings that have been dried out may cause a vehicle's wheel to stop turning or increase resistance to spin, which can cause poor gas mileage. When loading and unloading a boat into a body of water, the wheels of the trailer get submerged beneath the water. The water that the wheels get exposed to removes lubricant from the bearings and contributes to drying them out, especially if the water is salt water.

The wheels on a trailer each have a wheel hub with a bearing. Many trailer owners use automatic greasers to lubricate the bearings within the wheel hub. An example of the automatic greater is the product sold commercially under the brand name Bearing Buddy™ (a registered trademark of Bearing Buddy, Inc.). These automatic greasers are threaded or pressure-fitted and attached on the outer part of the wheel end bearing and onto the center section of the wheel hub assembly.

The wheels of these trailers often are subject to harsh environments such as rolling over train tracks or being constantly submerged in water, causing the automatic greasers attached to the wheel hubs to become loose or even detached from the wheel hubs. The continuous exposure to harsh environments can become costly for a trailer owner to constantly need to replace the automatic greasers. It can also cause the bearing to dry out and ruin the bearing, hub, spindle, and/or the wheel. In some instances, drying out can cause the bearing to overheat if it is in use, while heat can further cause destruction of trailer components or even a fire. Replacing the damaged parts resulting from these scenarios is quite expensive. Moreover, if any of these components become dislodged during use on a vehicle, the dislodged component can become a dangerous object to other drivers and passengers in cars also traveling on a roadway. The components are usually dislodged under extreme pressure and can impact or break windshields or other parts a vehicle.

Accordingly, a need exists for a modification to current wheel hubs and automatic/hub greasers to prevent hub wheel bearings from drying out and being destroyed. Consequently, the vehicle may be rendered immobile.

### BRIEF SUMMARY OF THE INVENTION

The disclosed subject matter provides a retaining clip for retaining an automatic greaser. The clip comprises a metal body including a first wing grip and a second wing grip connected via a bridge section. A first prong may extend from the first wing grip to a first end while a second prong may extend from the second wing grip to a second end. Tips positioned at each prong end may extend toward the other of the first and second prongs. A compressive force applied by the prongs assist in securely positioning the first and second ends into respective orifices on the outer surface of a hub body. The metal body may be aligned along a retaining plane when the clip is in an engaged configuration.

A system is provided for retaining an automatic greater to a wheel hub. The system includes a hub assembly having a hub base and a hub body. The hub body includes at least one friction reducing element positioned within the hub body (such as a bearing). An automatic greater may be affixed to a distal end of the hub body. A retaining clip, such as the clip described previously, includes a metal body and engages both the automatic greater and the hub body. When in an engaged configuration (engaging the automatic greater and hub assembly), first and second wing grips may apply opposing spring forces to the interior surface of the automatic greater so that the clip is secured to the automatic greaser. First and second prongs extending from the wing grips may be biased inward so that tips affixed to the prong ends are able to removably engage the hub body. The metal body, when engaged, may be aligned along a retaining plane extending along the length of the system.

A method is provided for manufacturing an automatic greater retaining system. The method includes providing a metal strand and forming it into a retainer configured to retain an automatic greaser. The retaining clip, such as the clip described previously, includes a metal body configured to engage both the automatic greater and the hub body. The first and second wing grips of the metal body may then engage an automatic greaser. An outer surface of a hub body may also be engaged by the retainer tips so that the retainer is aligned along a retaining plane when in the engaged configuration.

### BRIEF DESCRIPTION OF THE DRAWINGS

The disclosed subject matter, objectives, and advantages thereof, will best be understood by reference to the following detailed description of an illustrative embodiment when read in conjunction with the accompanying drawings, wherein:

FIG. 1 displays a close-up frontal view of an automatic greater clip, as shown and described herein.

FIG. 2 displays a close-up side view of an automatic greater clip, as shown and described herein.

FIG. 3 displays a perspective view of an automatic greater clip configured to engage an automatic greater and hub assembly, as shown and described herein.

FIG. 4 displays a method for manufacturing an automatic greater retaining system.

### DETAILED DESCRIPTION

Reference now should be made to the drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof

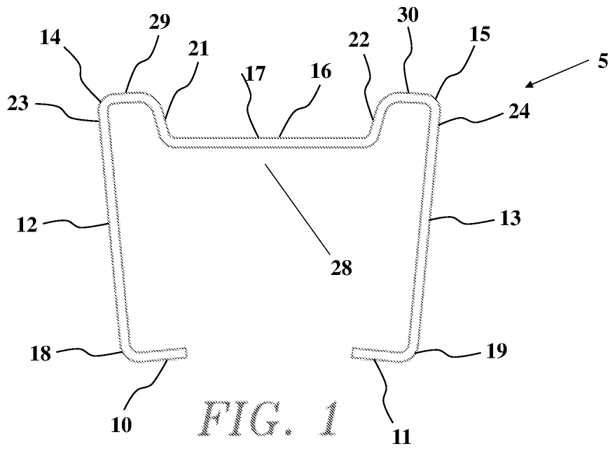

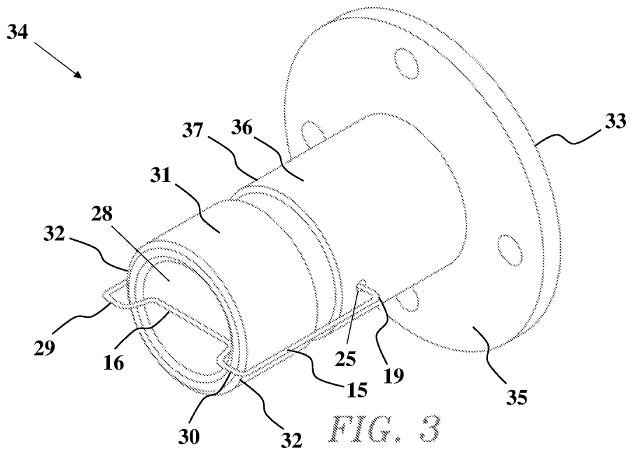

FIG. 1 displays a close-up frontal view of an automatic greater retaining clip 5 (or apparatus 5), as shown and described herein. Detachment of an automatic greater 31 from a wheel bearing may result in the destruction and drying out of a wheel's bearing. Applying clip 5 of FIG. 1 to an automatic greater 31 and hub assembly 33 (FIG. 3) may securely retain the automatic greater 31 to hub assembly 33. Clip 5 comprises a metal body 17 including a first wing grip 14 and a second wing grip 15 connected via a bridge section 16 (affixed to inner jaws 21,22). Bridge section 16 may be configured to abut at least one of an automatic greater cavity 28 and a greater cover/bra (not depicted) when cover is applied to the distal end of automatic greater 31 (and clip 5 is in an engaged configuration). Additionally, bridge section 16 may comprise a length shorter than that of the inner diameter of the exterior face of automatic greater 31 which, in some cases, is under 3.5 inches in diameter for some trailers, so that first and second wing grips 14,15 are properly secured to lips 32 of a sidewall of automatic greater 31. It is noted that each wing grip 14,15 provides stability to and further secures an automatic greater 31 to a distal end of a hub assembly 33.

First and second prongs 12,13 are attached to the outer jaws 23,24 of respective first and second wing grips 14,15. First prong 12 may extend from the first wing grip 14 to a first end 18 while a second prong 13 may extend from the second wing grip 15 to a second end 19. Tips 10,11 positioned at each prong end 18,19 may extend toward the other of the first and second prongs 12,13. A compressive force applied by the prongs 12,13 assist in securely positioning the first and second ends 18,19 into respective orifices 25 (only one orifice depicted in FIG. 3) on the outer surface 37 of a hub body 36. The metal body 17 may be aligned along a retaining plane (not depicted) when clip 5 is in an engaged configuration. When clip 5 is in an engaged configuration, each of the first and second wing grips 14,15 are configured to apply at least one compressive force to an interior surface of automatic greater 31.

In embodiments, each of the first prong 12 and the second prong 13 are tensioned inward toward the tension axis when clip 5 is in a disengaged configuration (as shown in FIG. 1).

In embodiments, metal body 17 may comprise tension wire. Use of tension wire may allow a user of clip 5 to use his/her hands to pull apart first and second prongs 12,13 away from a tension axis and place clip 5 on to automatic greater 31 and hub assembly 33 as well as pull apart first and second prongs 12,13 away from the tension axis and remove clip 5 from automatic greater 31 and hub assembly 33.

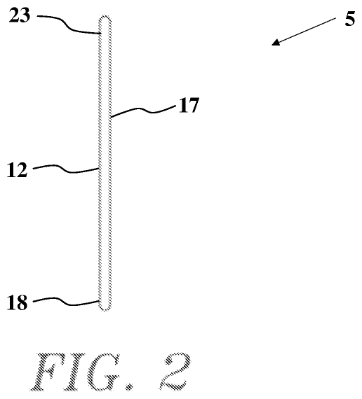

As shown in FIG. 2, metal body 17 comprises a flat configuration. The flat configuration (two dimensionality) allows clip 5 to be aligned along the retaining plane when clip 5 is in an engaged configuration, which is shown in FIG. 3.

FIG. 3 displays a perspective view of an automatic greater clip 32 configured to engage an automatic greater 31 and hub assembly 33, as shown and described herein. As shown, clip 5 is affixed to automatic retainer 31 and hub assembly 33 along a retaining plane (extending along metal body 17 and passing through the engagement points of clip 5 with automatic greater 31 and hub assembly 33). This combination of the automatic greater clip 32, the automatic greater 31, and hub assembly 33 may be referred to collectively as automatic greater retaining system 34 that is configured to retain an automatic greater 31 to a hub assembly 33. The hub assembly 33 has a hub base 35 and a hub body 36. Hub body 36 includes at least one friction reducing element (not depicted) positioned within the hub body 36 (such as a bearing that may support or be subject to a radial load, which supports a vehicle's weight and/or a thrust load, which provides cornering forces when a vehicle turns). An automatic greater 31 may be affixed to a distal end of the hub body 36. A retaining clip 5, such as the clip described previously found in FIG. 1, includes a metal body 17 and engages both the automatic greater 31 and hub body 36. When in an engaged configuration, the metal body 17 of clip 5 may simultaneously engage an interior surface of automatic 31 greater and an outer surface 37 of the hub body so that the automatic greater 31 is secure and removably affixable from hub body 36. Also, when in the engaged configuration, the first and second wing grips 14,15 may apply opposing spring forces to the interior surface of the automatic greater 31 for securement to automatic greater 31.

Lower retaining sections 29,30 of the first and second wing grips 14,15 may keep the inner jaws 21,22 and outer jaws 23,24 in the proper position so that tension forces are applied to lips 32 of the sidewall of automatic greater 31 and clip 5 is further secured to automatic greater 31. First and second prongs 12,13 extending from the wing grips 14,15 may be biased inward so that the tips 10,11 affixed to the prong ends 18,19 are able to removably engage the hub body. The metal body 17, when engaged, may be aligned along the retaining plane extending along the length of system 34. In embodiments, each of the lower retaining sections 29,30 may be substantially parallel to respective ones of the pair of tips 10,11. In further embodiments, each of the first tip 10 and the second tip 11 may be substantially parallel with bridge section 16 when clip 5 is in an engaged configuration.

In order to provide additional support for automatic greater 31, the pair of tips 10,11 may each engage one of a pair of orifices 25 (other orifice not depicted) that are symmetrically spaced from one another on the outer surface 37 of hub body 36. Additionally, clip 5 may be positioned to abut the automatic greater 31 and hub body 36 along the retaining plane when clip is in an engaged position.

It is noted that the shape of clip 5 may allow a user to easily insert and remove the clip 5 from an automatic greater and wheel bearing. The shape of clip 5 may be designed in a way that allows the user to grip the clip 5 at the first and second wing grips 14,15, allowing for comfortable and easy insertion and removal of clip 5. Furthermore, as shown in FIG. 2, clip 5 has a sleek, light-weight design that, in embodiments, may include a cylindrical frame that provides ease of use for a user of clip 5.

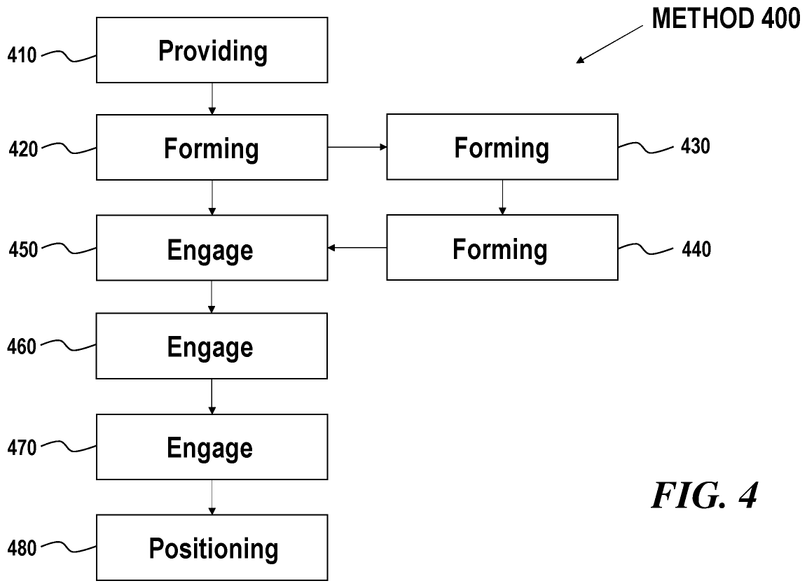

FIG. 4 displays a method 400 for manufacturing an automatic greater retaining system 34. Method 400 includes providing 410 a metal strand (not depicted) and forming 420 the metal strand into a retainer 5 configured to retain an automatic greater 31. An additional forming step 430 may include forming 430 each of the first wing grip 14 and the second wing grip 15 substantially parallel to the pair of tips 10,11. Another additional forming step 440 may include forming 440 each of the first and second wing grips 14,15 in a shape configured to apply at least one compressive force (via inner jaws 21,22) to an interior surface of the automatic greater 31 when the retainer 5 is in an engaged configuration.

Retainer 5, such as the clip 5 described previously, includes a metal body 17 and is configured to engage both the automatic greater 31 and the hub body 36. First and second wing grips 14,15 of the metal body 17 may then engage 450 an automatic greater 31 (as described previously). An outer surface 37 of a hub body 36 may also be engaged 460 by retainer tips 10,11 so that retainer 5 is aligned along the retaining plane when in an engaged configuration. In order to provide additional support for automatic greater 31, the pair of tips 10,11 may each engage 470 one of a pair of orifices 25 (other orifice not depicted) that are symmetrically spaced from one another on the outer surface 37 of hub body 36. Furthermore, retainer 5 may be positioned 480 to abut the automatic greater 31 and hub body 36 along the retaining plane.

In embodiments, a drill may be used to form round orifices 25 (other orifice not depicted) in hub body 36.

### ELEMENTS LIST

retaining clip 5

left tip 10

right tip 11

first prong 12

second prong 13

first wing grip 14

second wing grip 15

bridge section 16

metal body 17

first prong end 18

second prong end 19

inner jaws 21,22

outer jaws 23,24

orifices 25 (only one orifice depicted in FIG. 3)

greater cover/bra (not depicted)

automatic greater cavity 28

lower retaining sections 29,30

automatic greater 31

lips 32

(wheel) hub assembly 33

automatic greater retaining system 34

hub base 35

hub body 36

outer surface 37

In embodiments, metal body 17 may comprise a coating that may abut at least a portion of the outer surface of metal body 17.

It is noted that the space between first prong 12 and second prong 13 may allow a user to insert his/her fingers into the space, moving first and second prongs 12,13 into an open, disengaged configuration (pulling first and second prongs 12,13 away from the tension axis as well as pulling left and right tips 10,11 out of orifices 25 [and other orifice not depicted]) for the insertion and removal of clip 5 from automatic greater 31 and hub assembly 33.

It is noted that retaining clip 5 may be utilized in an automatic greater retaining system 34 that is not associated with wheel hub assemblies.

For the purposes of this disclosure, the terms “clip”, “retaining clip”, “retainer”, “automatic greater clip”, “automatic greater retaining clip”, and “apparatus” may be synonymous.

For the purposes of this disclosure, the terms “hub assembly” and “wheel hub assembly” may be synonymous.

For the purposes of this disclosure, the term “engaged configuration” may refer to clip 5 engaging both the automatic greater 31 and the hub assembly 33 (as shown in FIG. 3), while the term “disengaged configuration” may refer to clip 5 not engaging anything (as shown in FIG. 1).

A plurality of additional features and feature refinements are applicable to specific embodiments. These additional features and feature refinements may be used individually or in any combination. It is noted that each of the following features discussed may be, but are not necessary to be, used with any other feature or combination of features of any of the embodiments presented herein.

Unless otherwise defined, all technical and scientific terms used herein have the same meanings as are commonly understood by one of ordinary skill in the art to which this disclosure belongs. Although methods similar or equivalent to those described herein can be used in the practice or testing of the present disclosure, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present disclosure is not limited to what has been particularly shown and described hereinabove. Rather, the scope of the present disclosure is defined by the appended claims and includes both combinations and sub-combinations of the various features described hereinabove as well as variations and modifications thereof, which would occur to persons skilled in the art upon reading the foregoing description.

I claim:

1. An apparatus for retaining an automatic greaser, comprising:
a metal body, the metal body including:
a first wing grip spaced from a second wing grip via a bridge section;
a first prong extending from the first wing grip to a first end;
a second prong extending from the second wing grip to a second end; and
a pair of tips, each of the pair of tips extending from a respective one of the first end and the second end of the first and second prongs toward the other of the first and second prongs;
and
wherein the metal body is aligned along a retaining plane when in an engaged configuration.

2. The apparatus of claim 1, wherein the apparatus is a retaining clip.

3. The apparatus of claim 1, wherein the apparatus is configured to engage a wheel hub body.

4. The apparatus of claim 1, wherein each of the first wing grip and the second wing grip comprises a lower retaining section substantially parallel to the pair of tips.

5. The apparatus of claim 1, wherein each of the first prong and the second prong are tensioned inward toward a tension axis when in a disengaged configuration.

6. The apparatus of claim 1, wherein each of the first tip and the second tip are substantially parallel with the bridge section when in an engaged configuration.

7. The apparatus of claim 1, wherein the bridge section is configured to abut at least one of a cavity of an automatic greater and a greater cover.

8. An automatic greater retaining system, comprising:
a hub assembly having a hub base and a hub body, the hub body including at least one friction reducing element positioned within the hub body;
an automatic greater affixed to the hub body;
a retainer having a metal body, the metal body including;
a first wing grip spaced from a second wing grip via a bridge section;
a first prong extending from the first wing grip to a first end;
a second prong extending from the second wing grip to a second end; and
a pair of tips, each of the pair of tips extending from a respective one of the first end and the second end of the first and second prongs toward the other of the first and second prongs and engaging an outer surface of the hub body with the pair of tips;
and
wherein the metal body is aligned along a retaining plane when in an engaged configuration.

9. The system of claim 7, wherein the hub body is a wheel hub body.

10. The system of claim 7, wherein each of the pair of tips engages a respective one of a pair of orifices symmetrically spaced from one another on the outer surface of the hub body.

11. The system of claim 7, wherein the retainer abuts the automatic greater and the wheel hub along the retaining plane.

12. The system of claim 7, wherein the bridge section is configured to abut at least one of a cavity of an automatic greater and a greater cover.

13. The system of claim 7, wherein the retainer simultaneously engages an interior surface of the automatic greater and an outer surface of the hub body when in an engaged configuration.

14. The system of claim 7, wherein each of the first and second wing grips are configured to apply at least one compressive force to an interior surface of the automatic greater when the retainer is in an engaged configuration.

15. A method for manufacturing an automatic greater retaining system, comprising:
providing a metal strand;
forming the metal strand into a retainer configured to retain an automatic greaser, the retainer comprising:
a first wing grip spaced from a second wing grip via a bridge section;
a first prong extending from the first wing grip;
a second prong extending from the second wing grip; and
a pair of tips, each of the pair of tips extending from a respective one of the first end and the second end of the first and second prongs toward the other of the first and second prongs;
engaging an automatic greater with the first wing grip and the second wing grip;
and
engaging an outer surface of a hub body with the pair of tips so that the retainer is aligned along a retaining plane when in an engaged configuration.

16. The method of claim 15, wherein the hub body is a wheel hub body.

17. The method of claim 15, further comprising forming each of the first wing grip and the second wing grip substantially parallel to the pair of tips.

18. The method of claim 15, further comprising engaging, via each of the pair of tips, a respective one of a pair of orifices symmetrically spaced from one another on the outer surface of the hub body.

19. The method of claim 15, further comprising positioning the retainer to abut the automatic greater and the hub body along the retaining plane.

20. The method of claim 15, further comprising forming each of the first and second wing grips in a shape configured to apply at least one compressive force to an interior surface of the automatic greater when the retainer is in an engaged configuration.
